(19) United States
(12) Patent Application Publication
(10) Pub. No.: US 2009/0222743 A1
(43) Pub. Date: Sep. 3, 2009

(54) Meme-Based Graphical User Interface And Team Collaboration System

(76) Inventor: Marc C. Hadfield, New York, NY (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/239,588

(22) Filed: Sep. 26, 2008

Related U.S. Application Data
(60) Provisional application No. 60/975,792, filed on Sep. 27, 2007.

(51) Int. Cl. G06F 3/048

(52) U.S. Cl. 715/753; 719/328

(57) ABSTRACT

The subject matter disclosed herein provides methods and apparatus, including computer program products, for graphically manipulating memes and collaborating with the memes in a distributed workflow system. In one aspect there is provided a method. The method may include creating a group of one or more members. A graphical user interface may be used to manipulate the meme. The meme may be associated with at least one member of the group. The meme may also be configured as a data object. Furthermore, the meme may include an identifier. Moreover, the method may include defining whether the meme is accessible to each of the one or more members. Related systems, apparatus, methods, and/or articles are also described.

### CROSS REFERENCE TO RELATED APPLICATION

This application claims the benefit under 35 U.S.C. §119(e) of the following provisional application, which is incorporated herein by reference in its entirety: U.S. Patent Application No. 60/975,792, filed Sep. 27, 2007, and entitled “Meme-Based Graphical User Interface And Team Collaboration System” (Attorney Docket No.: 36283-502PRO).

### BACKGROUND

This disclosure relates generally to graphical user interfaces and collaboration systems.

Most existing collaboration systems require significant operational overhead for administrative procedures and for managing data rights and security. This overhead makes collaboration less efficient, and makes short term ad-hoc collaboration impractical.

### SUMMARY

A team collaboration system and method reduces collaboration overhead, making ad-hoc collaboration efficient and practical. The team collaboration system and method are based on the principle that small group collaborators work well with each other most of the time, and that a pool of validated and authenticated users can be created, while removing that burden from the team formation process.

In another aspect there is provided a method. The method may include creating a. group of one or more members. A graphical user interface may be used to manipulate the meme. The meme may be associated with at least one member of the group. The meme may be configured as a data object. The meme may also include an identifier. Moreover, the method may include defining whether the meme is accessible to each of the one or more members.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1-10 illustrate aspects of a graphical user interface for a universal meme identification system.

FIGS. 11-24 and 26-27 illustrate aspects of a team collaboration system using a graphical user interface for a universal meme identification system.

FIG. 25 illustrates a team collaboration method.

Like reference symbols in the various drawings indicate like elements.

### DETAILED DESCRIPTION

This document describes a graphical user interface for a universal meme identification system (UMIS) and a team collaboration system using the UMIS and graphical user interface. A meme is a data object, such as a basic element of cultural inheritance, i.e. an abstract replicatory unit of information that is passed on from one human generation to another, much like a gene is the basic element of biological inheritance. General examples of memes include descriptive information about physical things, ideas, beliefs, values, and concepts.

An implementation of the UMIS uses a definition of unique identifiers associated with semantic concepts. A semantic concept is any concept which may be held in a person's mind that contains meaning, including physical things (both instances and classes), abstract concepts, events, or configurations of other semantic concepts. A semantic concept contains authoritative information.

The unique identifiers are associated with semantic concepts that are part of a semantic network. A semantic network is a set of semantic concepts which have defined relations among them. One or more information records associated with semantic concepts can be retrieved over the Internet or an Intranet, using one or more such identifiers and/or additional criteria, including general criteria. Details of the UMIS are described in U.S. Patent Application No. 60/930,794, filed May 17, 2007, and entitled “UNIVERSAL MEME IDENTIFICATION SYSTEM AND METHOD,” and U.S. patent application Ser. No. 12/122,591, filed May 16, 2008, and entitled “UNIVERSAL MEME IDENTIFICATION, both of which are incorporated herein by reference in their entirety.

Interface

A graphical user interface system that generates a graphical user interface (GUI) is described. The GUI represents a plurality of memes as graphical objects. The graphical objects are manipulable by the graphical user interface system according to one or more graphical manipulation schemes.

The manipulation schemes define a set of areas on the GUI, each area having an associated function (i.e. Search, etc.) that is executed on any memes that are graphically associated with the area (i.e. “drag and drop” of a meme into the area). The manipulation also includes the ability to use a cursor to enact an action that electronically attaches written text, URLs, electronic files or other memes to each meme or other forms of electronic information to each meme and store that information electronically.

As a series of examples, the associated functions include moving one or more graphic icons into an area of GUI associated with search and having a search performed associated with all manipulated memes. It includes taking and moving one or more graphic icons representing memes into an area of GUI associated with storage of memes and having that information saved for the user it in present from. It also includes taking and moving one or more graphic icons representing memes into an area of GUI associated with a group or team and the resulting action shares those memes with the group.

Examples of sharing memes with a group include all the above mentioned actions and the taking and moving one or more graphic icons representing memes into an area of GUI associated with a point in time on a calendar and having that icon represent the meme but also a point in time. It also includes taking and moving one or more graphic icons representing memes into an area of GUI that represents a task to be performed and having the icon represent the meme and the task that must be performed by an individual or group of individuals. Also, the taking and moving one or more graphic icons representing memes into an area of GUI can associate the meme with both a point in time and a task to be performed by a individual or group contemporaneously.

Manipulations are not mutually exclusive and can be executed simultaneously. This can also apply to the graphical depiction of a meme and its relation to all other memes in a defined set, and how that graphical depiction can be represented to a user, manipulated by a user according to a defined logic set, and used to produce an output (i.e. determining an outcome of some function based on the memes and their relations).

The GUI includes a number of areas that express various functions and communications with a backend of the system. Each area implements a function when selected or otherwise used by a user. An area can be represented by a box, a link, or a window, or any other graphical element to distinguish the area as an independent functional space within the GUI. Each area merely expresses a function of an Application Programming Interface (API), and as such, can be implemented and/or represented in any number of ways. However, the functions and/or processes executed and/or enabled by any one of the areas within the GUI are described with reference to the GUI element that enables them.

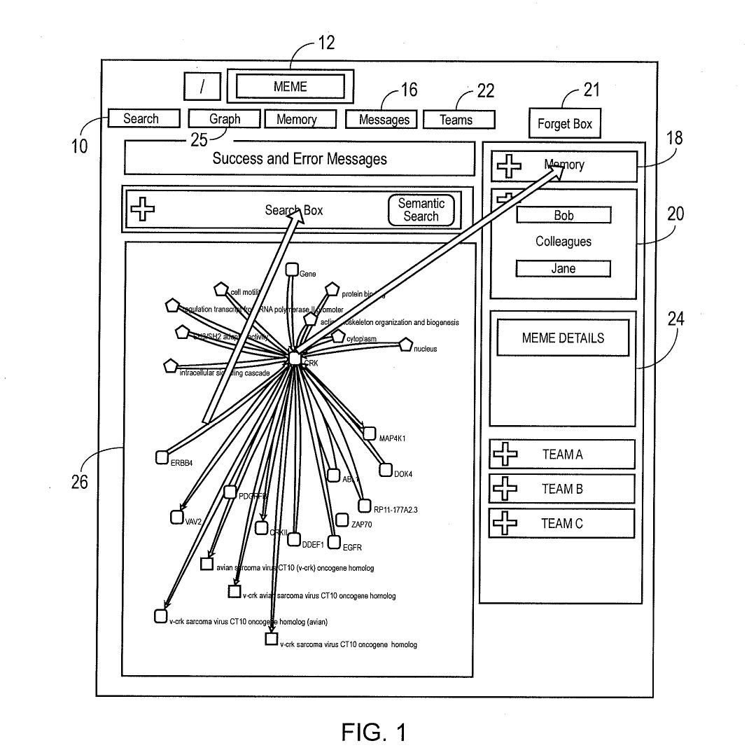

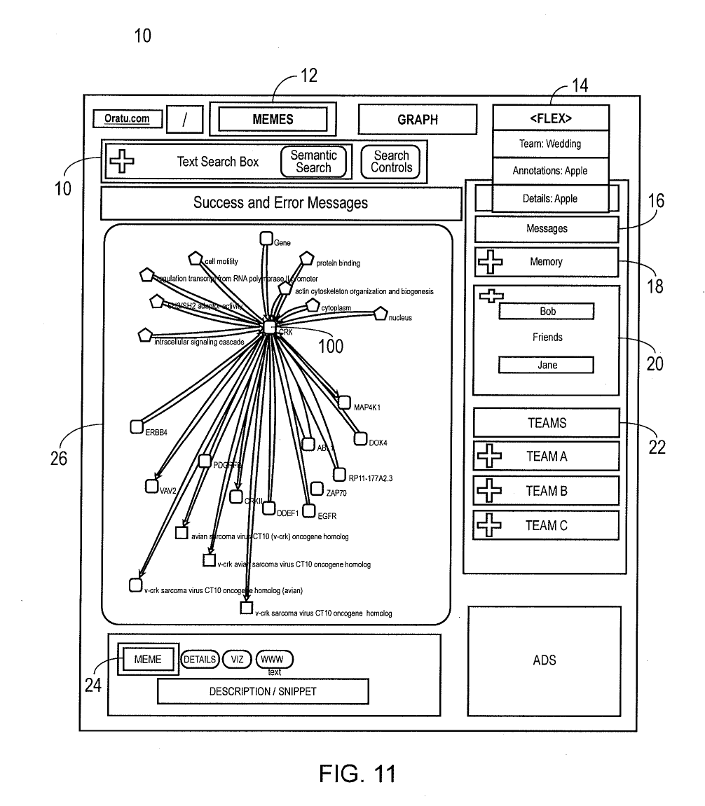

For instance, as illustrated in FIG. 1 and FIG. 11, a search area 10 is used to enable search using type written words, memes or UMIS identifiers in the database or on the web. A Meme area 12 can be highlighted, opened or activated during any examination of memes. A Flex area 14 (as shown in FIG. 11) enables one or more latest actions taken by a user within the GUI to be recorded, including searches, notification, messages, etc.

A Message area 16 enables the storing of all messages to and from users. The Message area can include an Inbox for storing and displaying messages from other users, and an Outbox for storing and displaying messages to other users. The Inbox and/or Outbox can be accessed by a user via selection of the Message area. A Memory area 18 provides long term storage of memes for a user, and can represents a set of Memes that are associated with a User or a Team, which association can be permanently stored.

Further shown in FIG. 1, a Friends/Colleagues area 20 enables a user to store memes associated with other related users, and which users can be represented in the Friends/Colleagues area 20. A Teams area 22 allows a user stores meme associated with groups of users around a common set of memes. The Teams area 22 can include Public/Private Options, which regulate access to the team by those outside the team, a Parent Topic that identifies the memes associated with the team, and a topic.

A Present Meme area 24 identifies the present meme being used while performing any function. The GUI can also include a Forget area 21 that enables memes to be erased from memory, teams, friends/colleagues or clipboard. The GUI can include a Graph area 26 that is enabled by a Graph control 25 and which is adapted to graphically show the active information resulting meme from a queried and the information related to that meme. The Graph area 26 can depict a Meme 100 and its relations to other nodes of information.

The GUI can also include a History register that is adapted to show the history of the memes examined by the user while using the graph. The GUI can also include a Clipboard adapted as a temporary holding place for memes. The Clipboard can represent a set of Memes that are associated with a User or a Team, and the association can be transient (i.e. not permanently stored).

FIG. 1 shows a graph consisting of nodes and edges. Memes are represented by nodes. The informational association between memes is represented by edges connecting one node to another. Both the nodes and edges can be manipulated on the GUI and moved from one area to another to enable a function. FIG. 1 depicts a node being dragged to “memory” for storage, and an edge being dragged to “search” to compose a query.

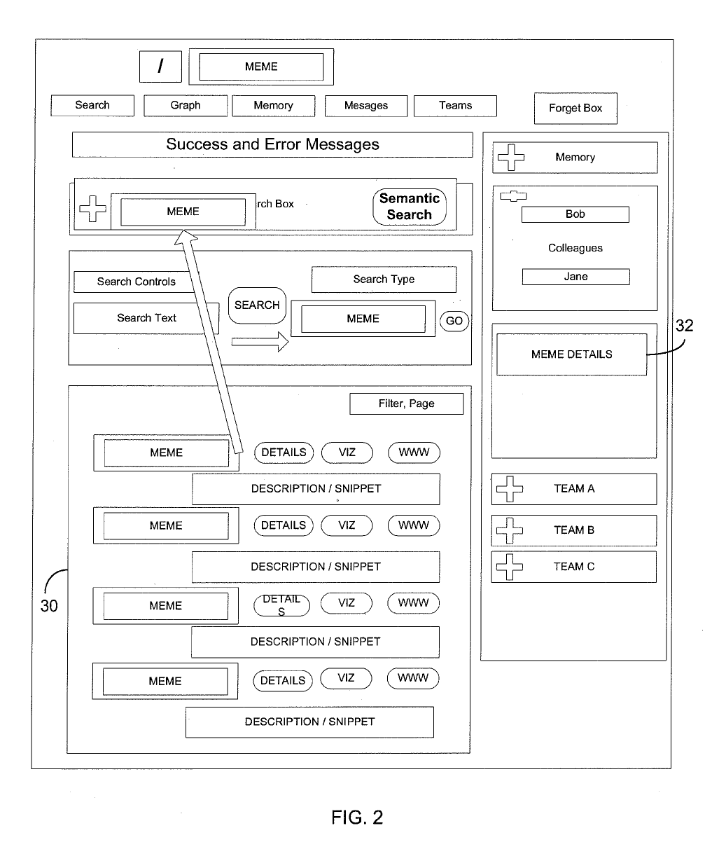

FIG. 2 illustrates further areas of the GUI to enable a number of other functions or processes. The GUI can include a Meme Registry area 30, as a tab or a box, that gives access to subparts of a particular meme that allow examination and manipulation of that meme. A Meme details area 32 enables a display of information related to that meme, including source of information and UMIS Identification. The Meme details area 32 can further include a Vote up/vote down control to allow users to comment on the validity meme details or meme itself, a Relationships control to identify and list memes that the subject meme is related to, as well as types of relations, an Annotations control that allows a user to attach notes to memes and to display the attached notes.

The Meme details area 32 can further include a Reference that displays a UMIS identifier input, an Ontology Import that allows the importation on ontological information in any ontological format, a Register that allows the identification and classification of a new meme, and an Editor that gives access to user to modify a meme's information.

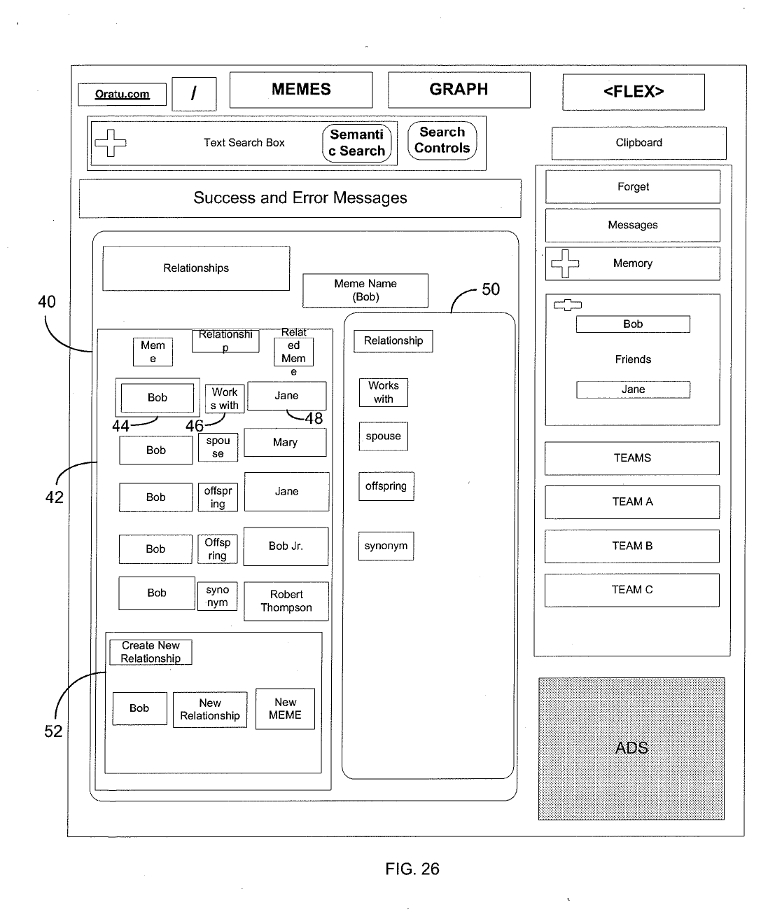

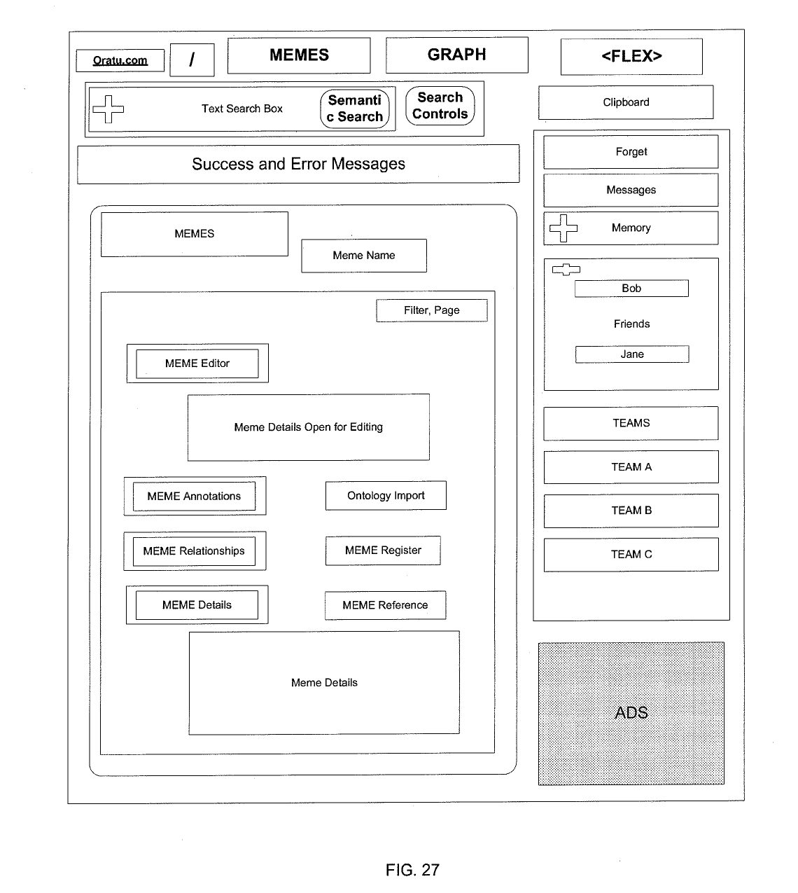

As shown in FIG. 26, the GUI can also include a Relationships area 40 that includes a Meme Relationship area 42 that lists a subject meme and all related memes and their relationships. The Meme relationship area 42 can include Subject meme areas 44, Relationship areas 46, and Related meme areas 48. The Relationship area 40 can further include a Pre-identified Relationships area 50 indicating all relevant relationships identified with the subject meme, and a New Relationship creation area 52 that identifies the subject meme and allows user to input a new related meme and relationship.

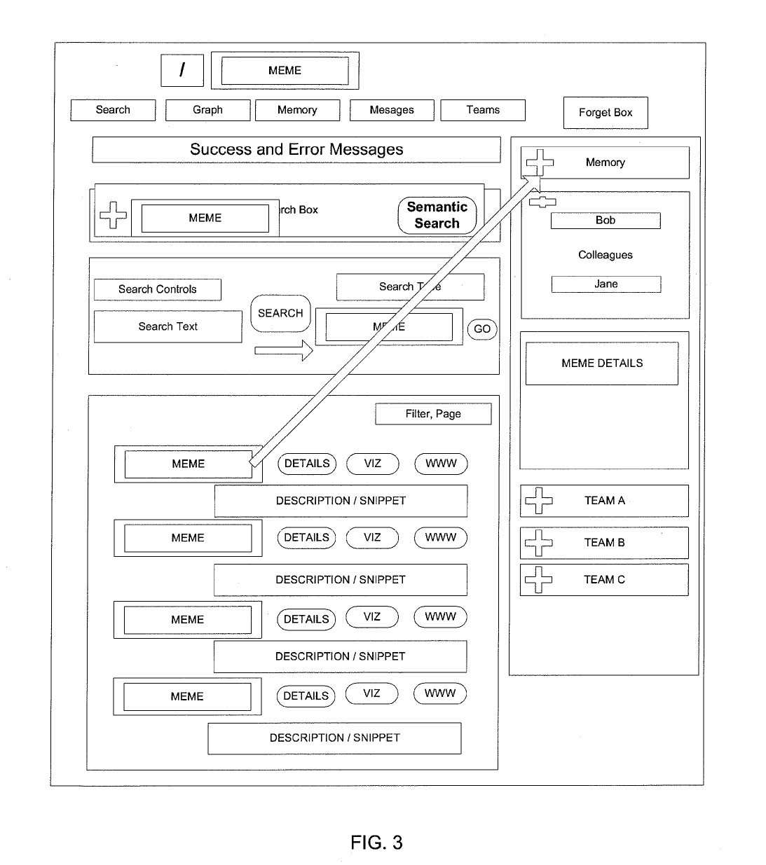

FIG. 2 also shows the list form of display and the moving of one or more graphic icons into an area of GUI associated with search and to have a search performed associated with that manipulated meme. FIG. 3 shows the list form of display and the moving of one or more graphic icons into an area of GUI associated with storage.

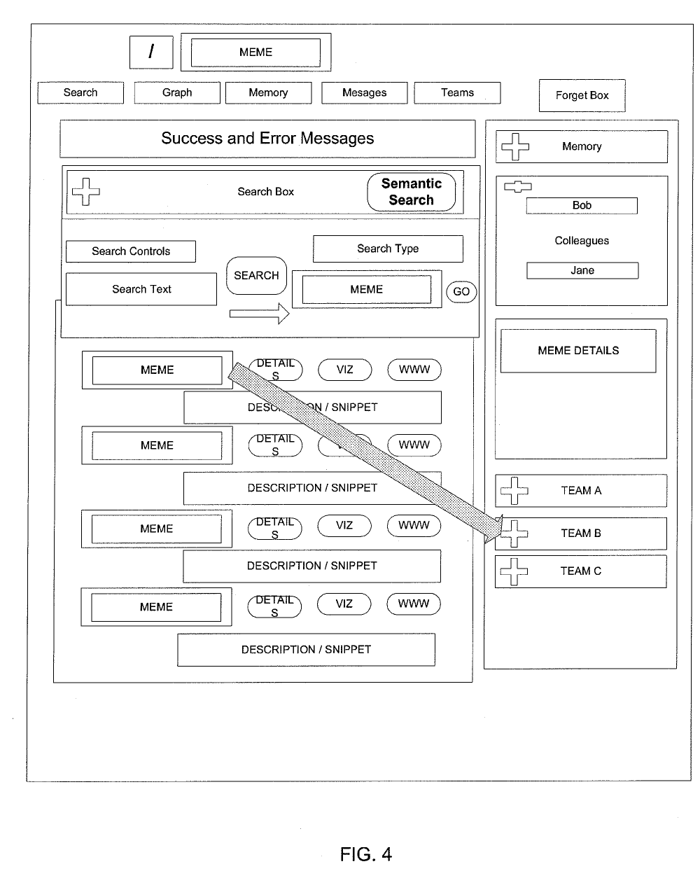

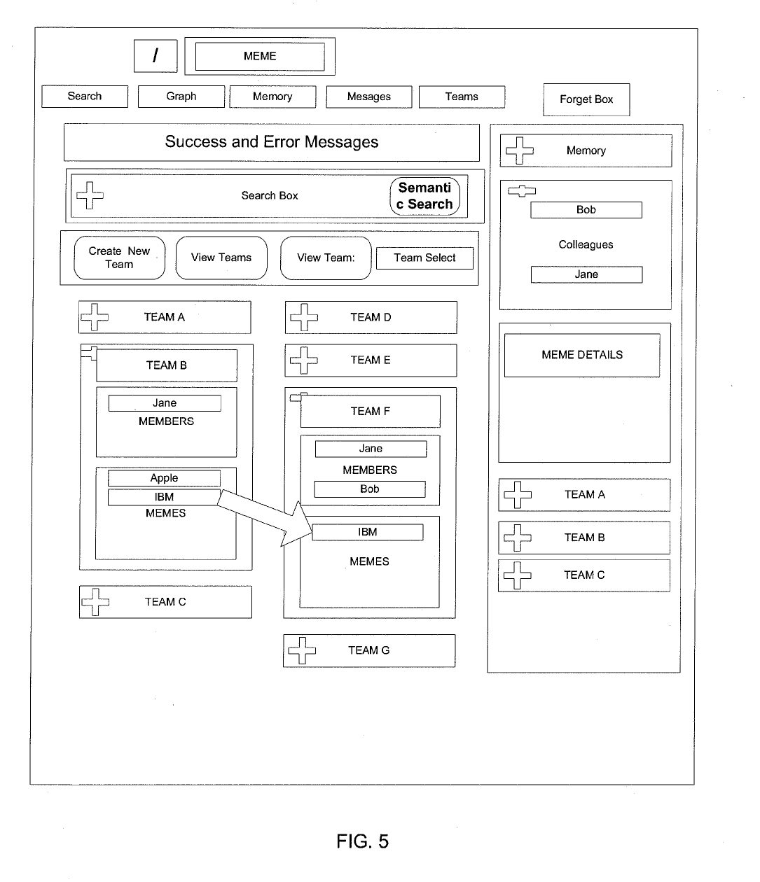

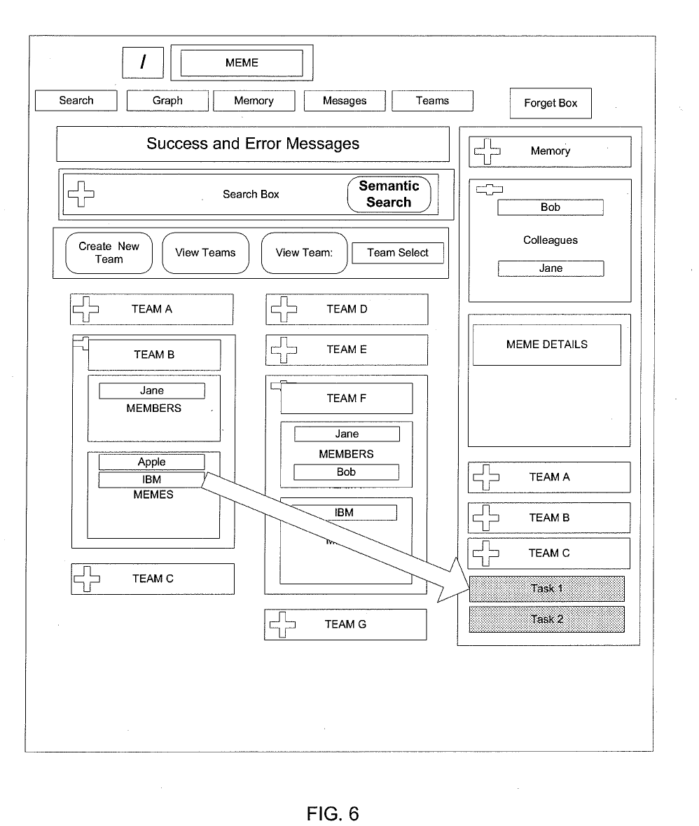

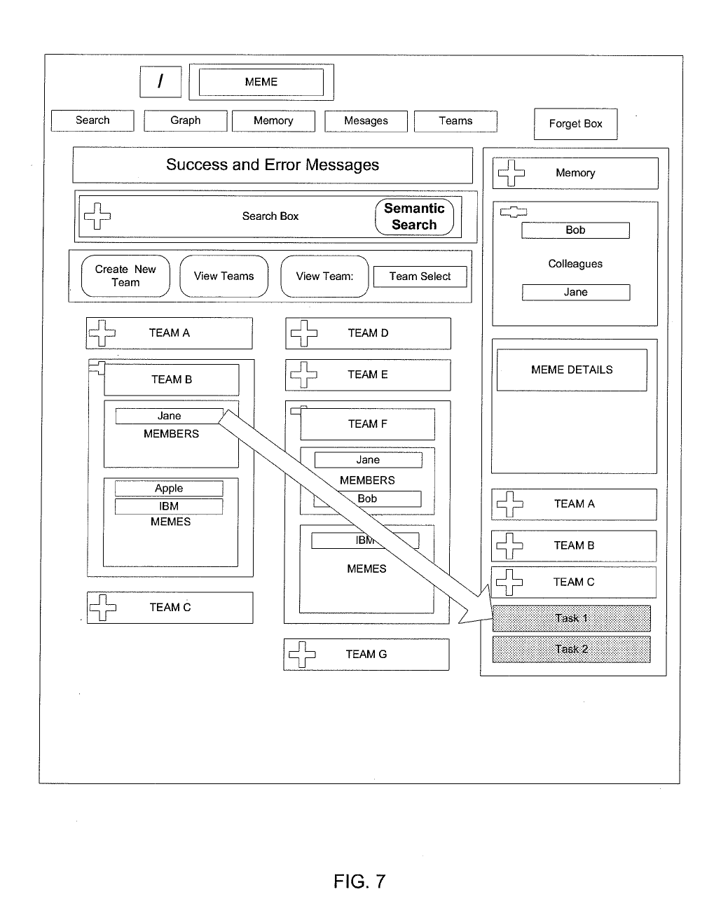

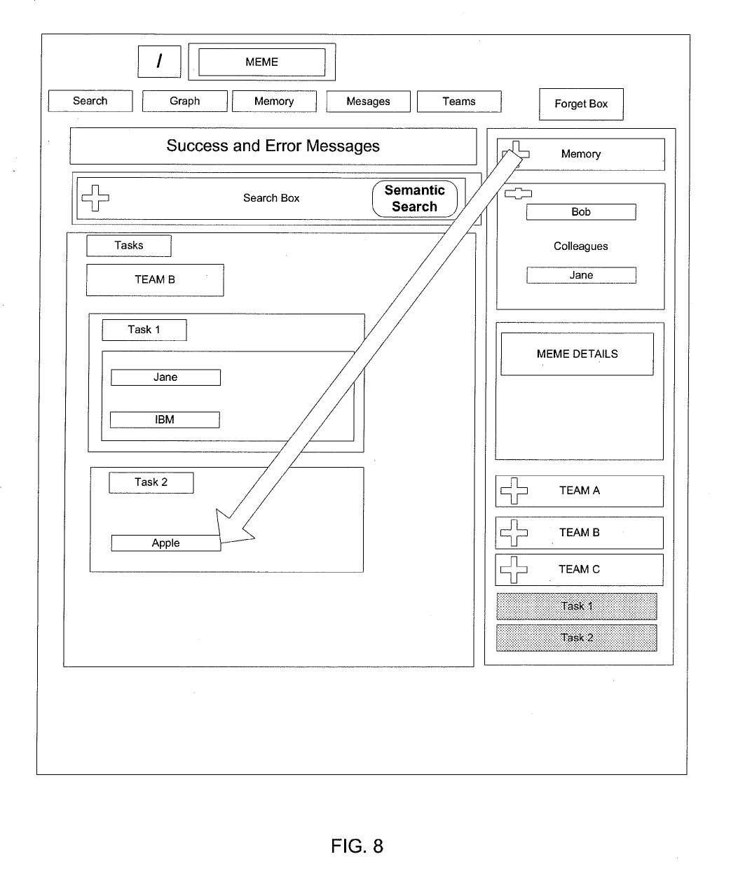

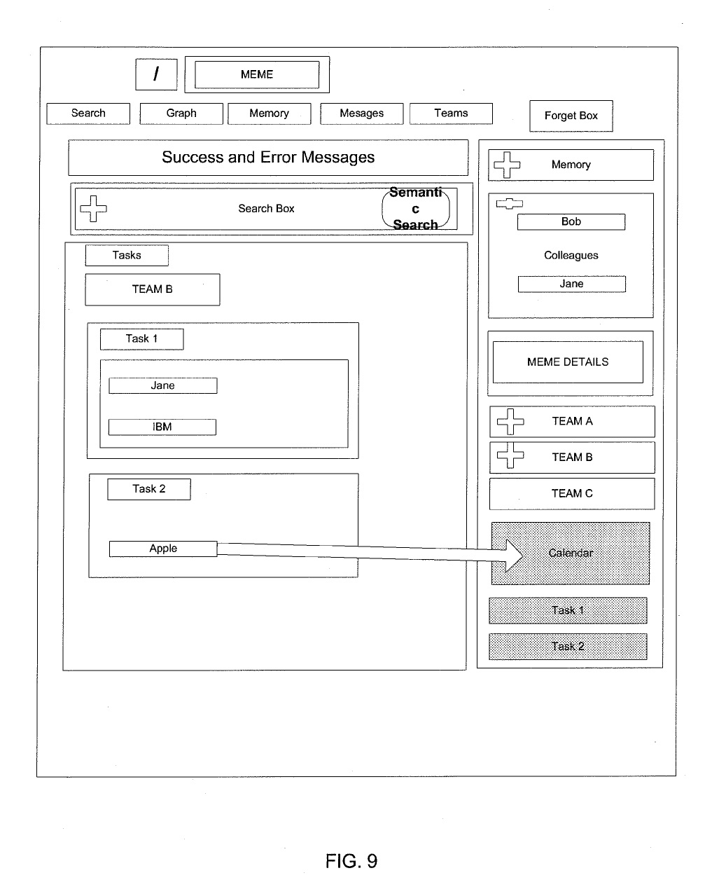

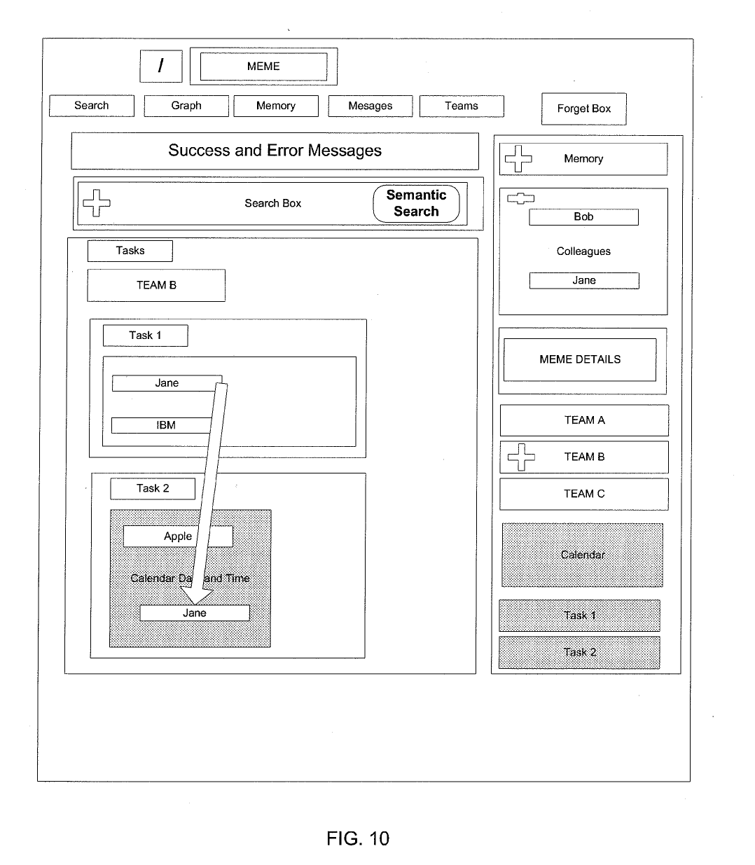

FIG. 4 shows the transfer of memes from an individual to a group or team. FIG. 5 shows the transfer of memes between a group or team. FIG. 6 shows the transfer of a first meme to be associated with a task. FIG. 7 shows the transfer of a second meme to be associated with the same task. FIG. 8 shows the transfer of a meme from Memory to a task associated with a team. FIG. 9 shows the transfer of a meme to be associated with a with a calendar date, thus having a point in time. FIG. 10 shows a meme associated with a task having a calendar date and a point in time joined with an individual by the manipulation of a graphical object representing that individual.

Team Collaboration

A team collaboration system and method are described, which reduce collaboration overhead, making ad-hoc online collaboration efficient and practical. The team collaboration system and method is used to create a pool of validated and authenticated users from which one or more collaborative teams can be formed to work on a common issue or problem.

The following are Data Object definitions used in a team collaboration system and method. A user represents a user using an information system. A team represents a collection of users sharing information in a collaborative group via an information system. A meme represents a person, place, organization, thing, or other concept. A URL (Uniform Resource Locater) represents a data object which contains the Internet accessible address of a document or binary file. An annotation represents a notation consisting of a textual comment, a binary file, a URL, a Meme, a User, or a Team that is associated with a particular Meme, Team, User, URL, or other Annotation.

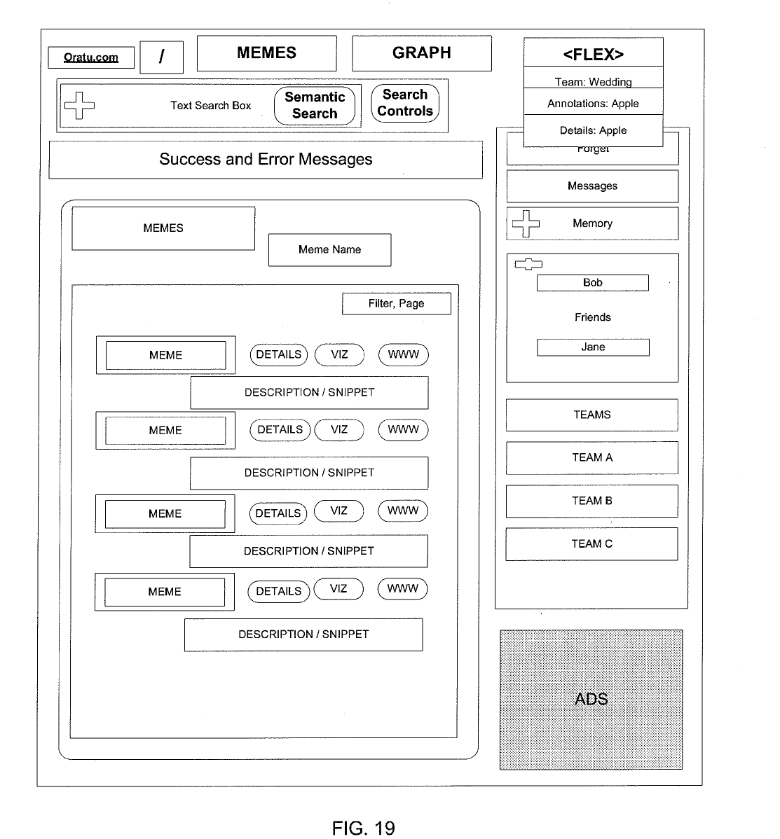

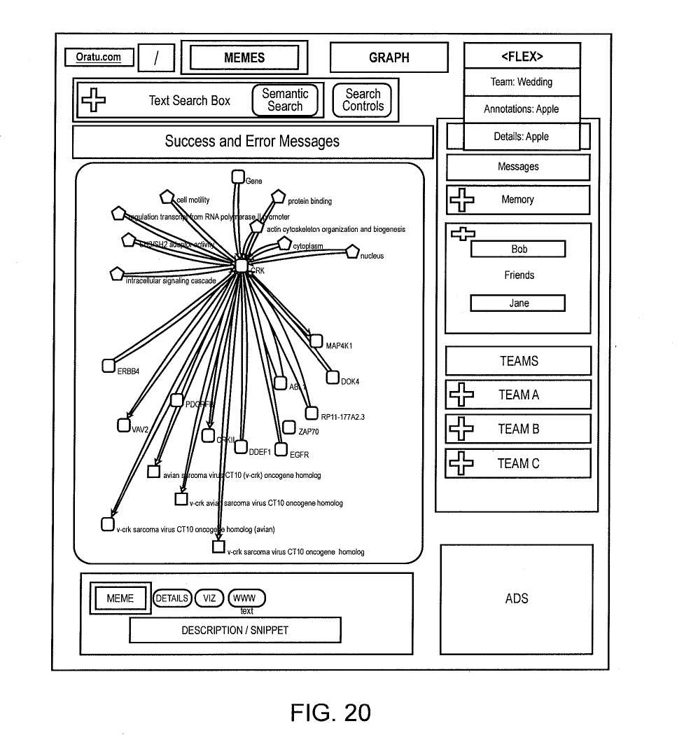

FIGS. 11-24 depict various GUIs that can be used to execute some or all of the team collaboration functions described above. FIG. 11 depicts an exemplary opening page of a team collaboration system, in which an individual's meme 10 is associated with semantic concepts and other items. The pentagon shapes 20 represent items new to the individual. An area 30 of the GUI can provide detail for the active meme 10.

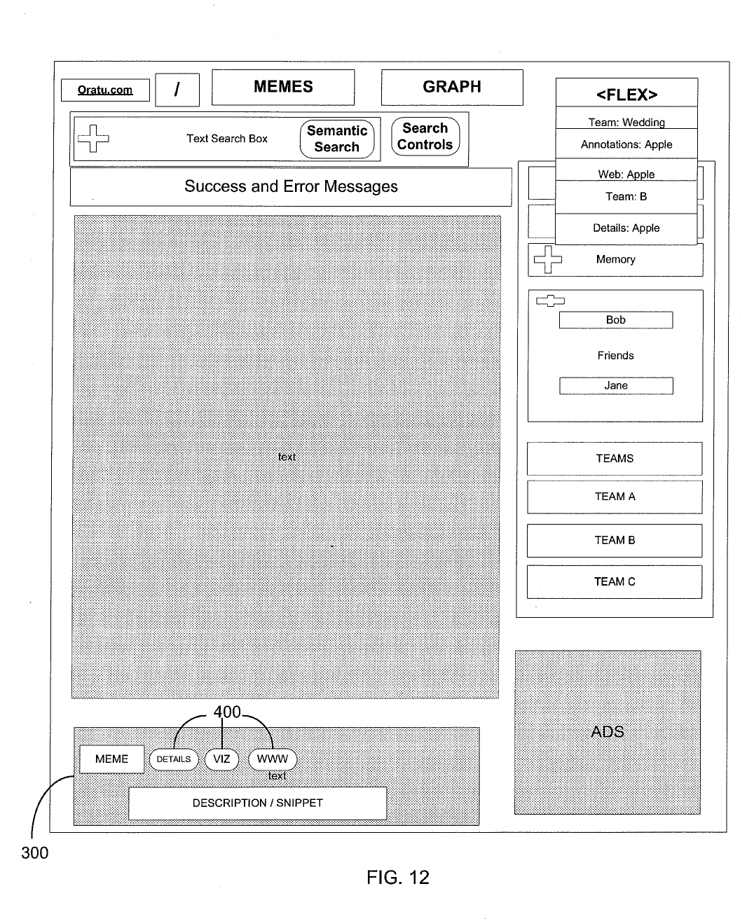

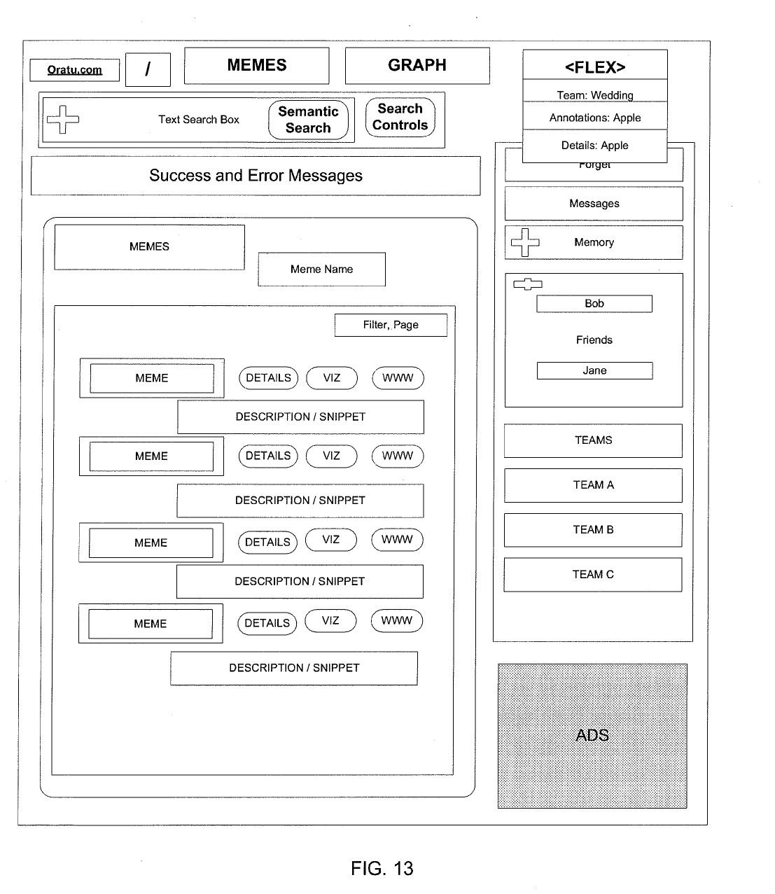

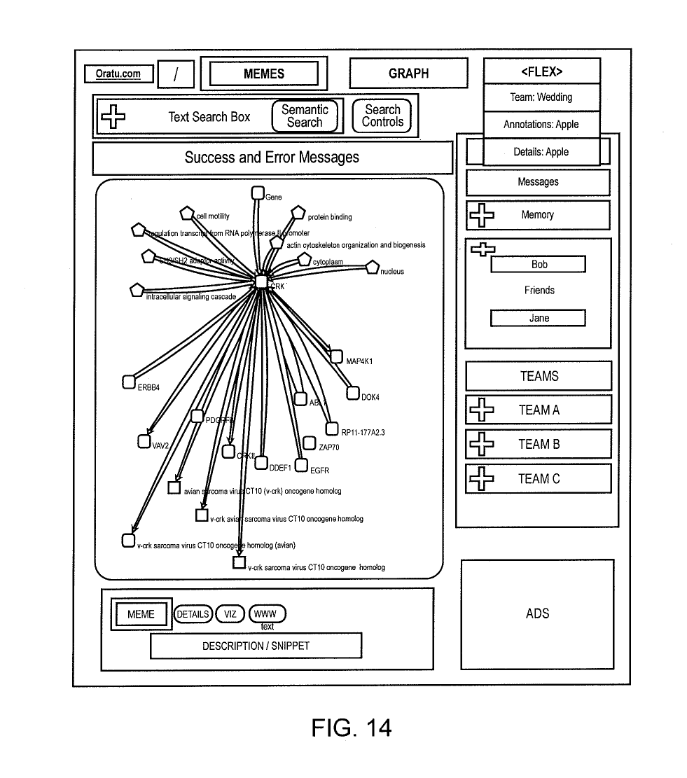

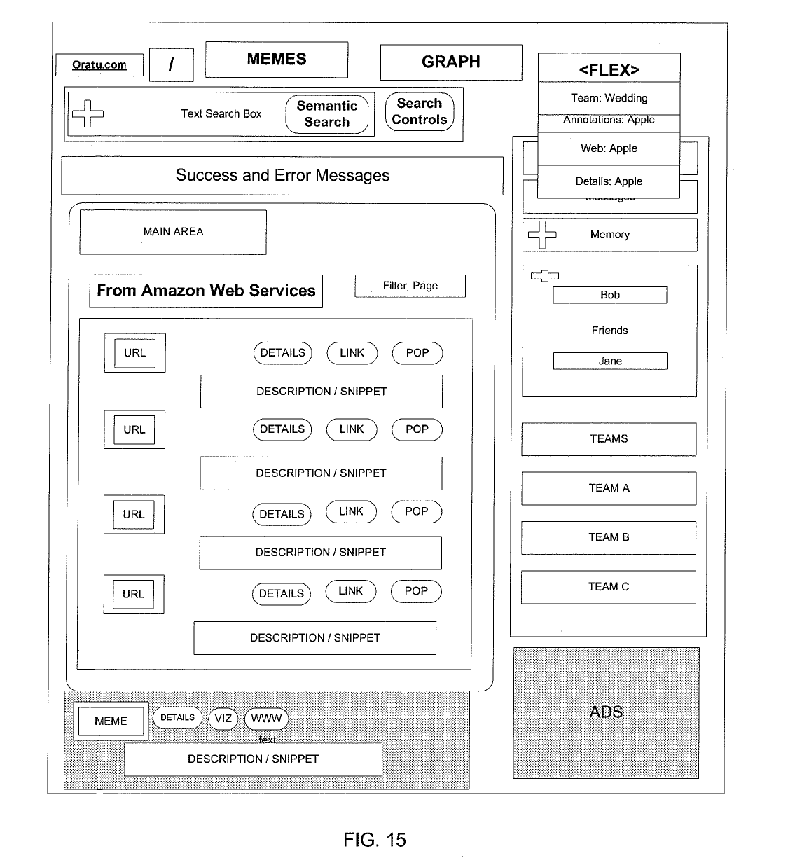

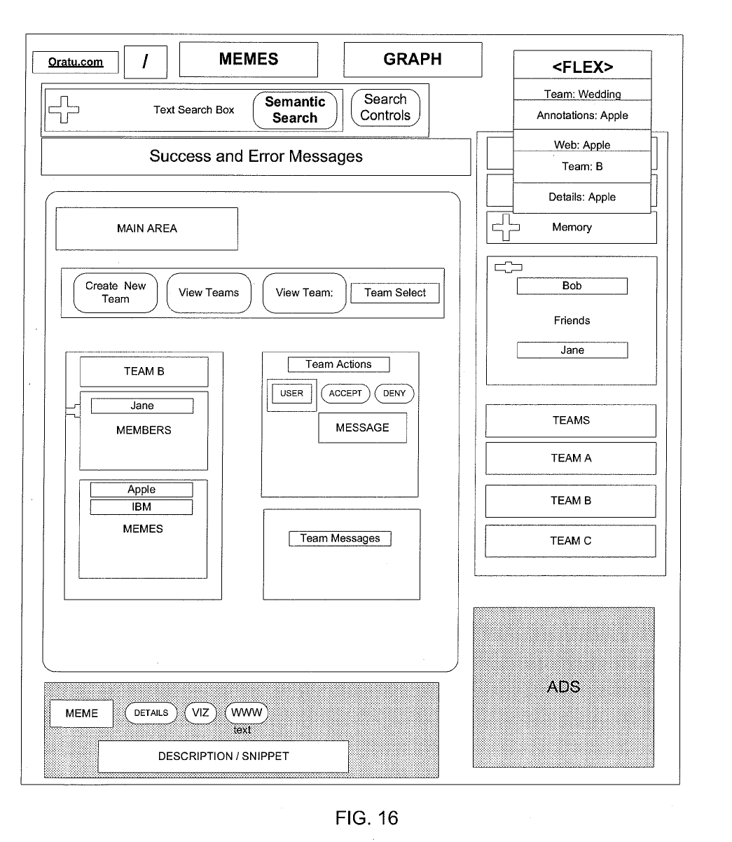

FIG. 12 depicts the area 300, in which buttons 400 or other user-selectable links or icons can be selected to access different screens. A number of memes can be displayed on a meme list page, as shown in FIG. 13, and an individual meme can be selected and navigated among its related nodes in a navigation window as shown in FIG. 14. FIG. 15 illustrates a meme list page that appears if a user selects details from one of the user selectable links, shown being www details. FIG. 16 shows a team main window for a team, i.e. a collection of users sharing information in a collaborative group, and the information is based on common memes, etc.

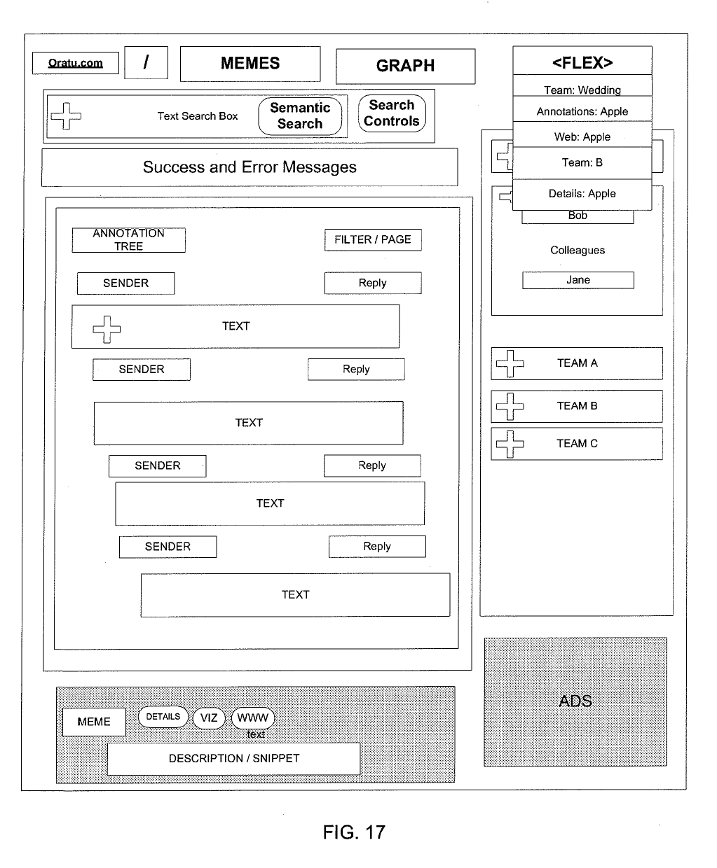

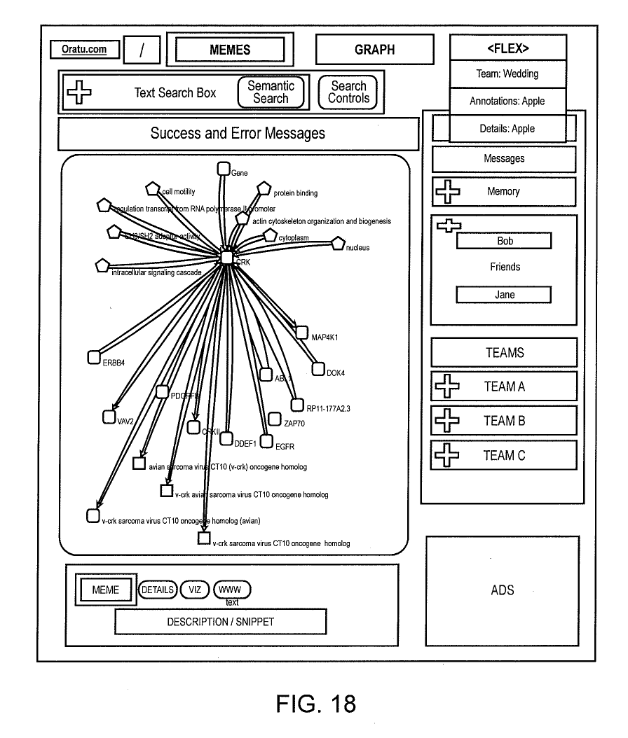

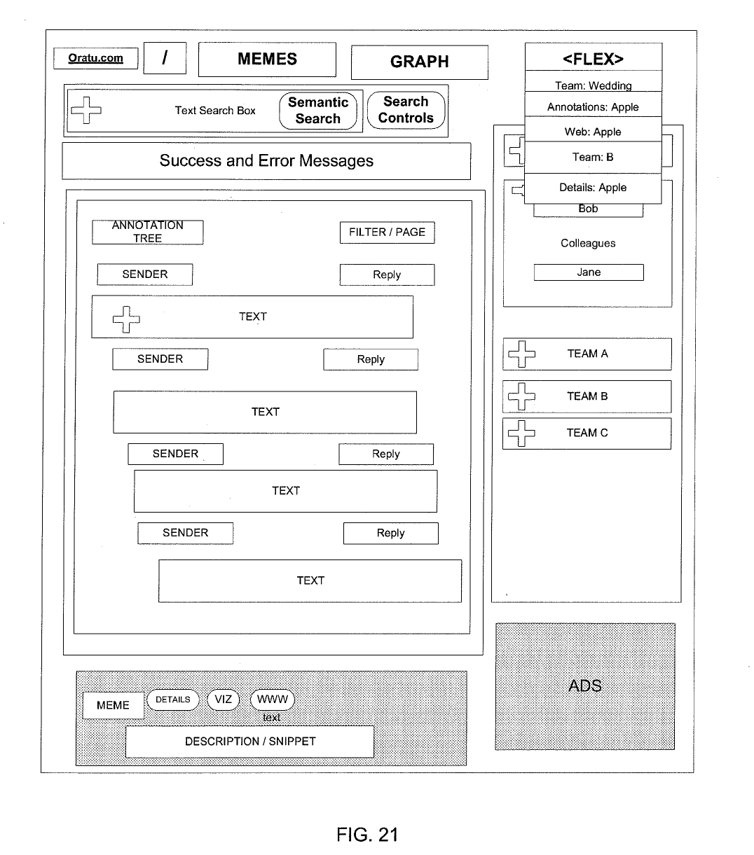

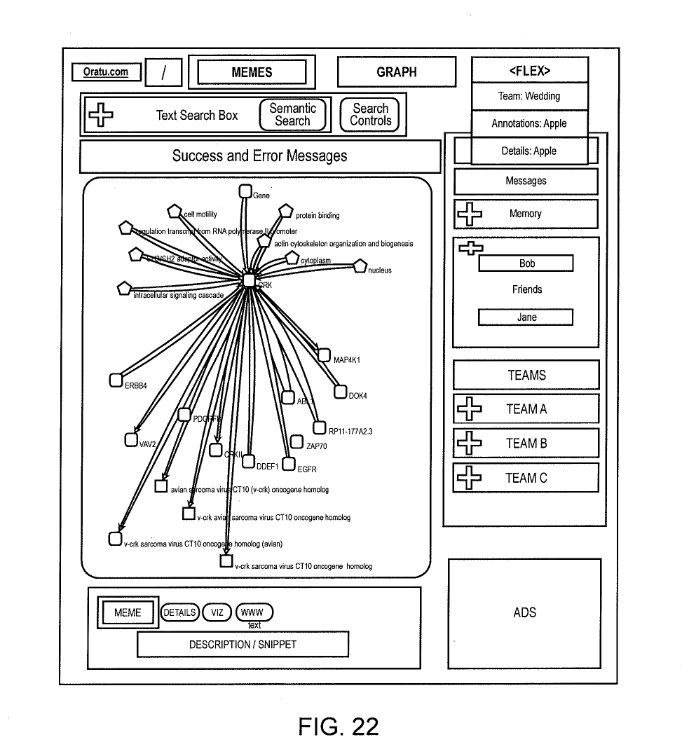

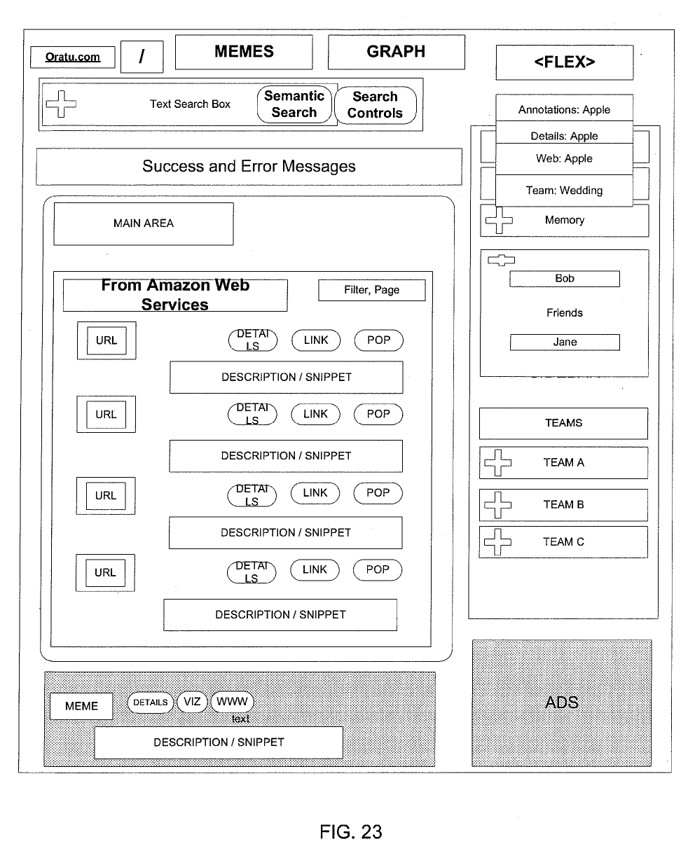

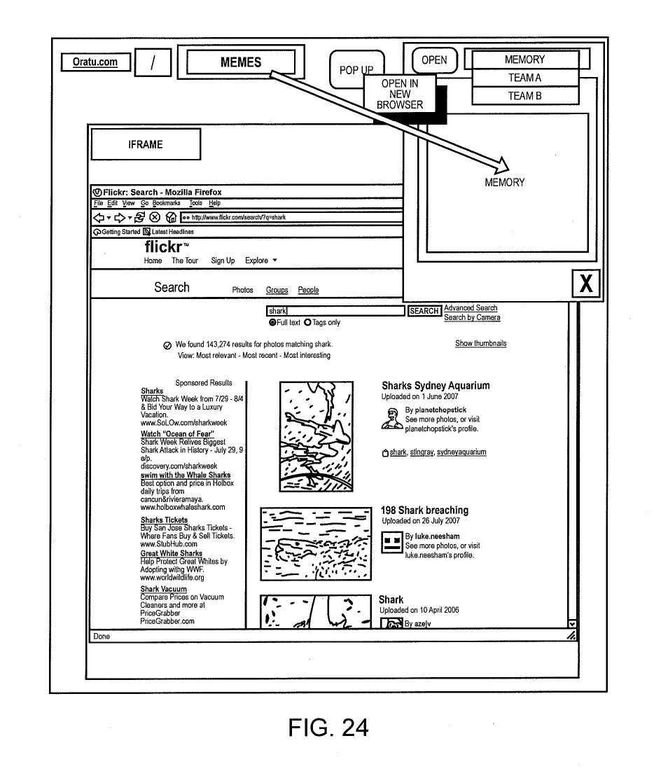

FIG. 17 illustrates an annotation tree for making annotations to a meme or related memes. An annotation may be obtained from the main page in FIG. 18 to the annotation page in FIG. 21, by clicking on an annotation icon 40. A user may select the “www” button to obtain a web page, as shown in FIG. 22, which then provides a URL list based on web search results using a meme shown in FIG. 23. FIG. 24 is an iFrame view of a selected meme.

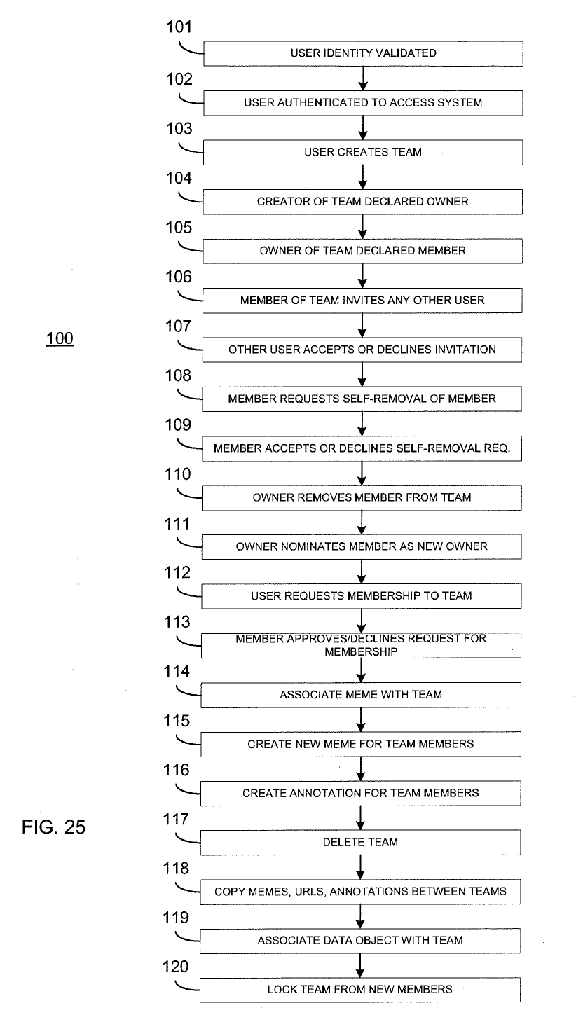

FIG. 25 illustrates a team collaboration method 100. At 101, a user identity is validated, preferably via email to a stated affiliation, however any method that determines a user is who they say they are can be used. At 102, the user is authenticated to access the system, preferably via secure password or other method, in which the identity of the person given access to the account matches the validated identity.

At 103 a user creates a team. A team may be created as Private, Semi-Public, or Public. In a Private team, information associated with the team is available only to team members, membership of a team is available only to team members, and the existence of the team is not available to non-members. In a Semi-Public team, information associated with the Team is available only to members, membership of a Team is available only to team members, and the existence of the team is available to all users. Finally, in a Public team, information associated with the team is available to all users, membership of a team is available to all users, and the existence of the team is available to all users. In all of the above cases, information can only be added to a team by team members.

In accordance with implementations of a team collaboration method or system, at 104 the creator of a team is declared the “owner” of the team, at 105 the owner of a team is declared a member of a team, and at 106 any member of a team may invite any other user of the information system to be a member. At 107 upon such invitation, another user may accept an invitation and immediately become a member of a team, or may decline the invitation and not become a member of the team.

A member may request that another member self-remove from the team, at 108. Any member may self remove him/herself from a team at any time, or a member may decline a request from another member to self-remove, at 109. At 110, an owner may remove a member from a team at any time. At 111, an owner may nominate a member as new owner, and upon acceptance by the nominated member, that nominated member becomes the owner of the team. However, the nominated member may decline becoming owner.

At 112, a user that is aware of the existence of a team may request membership in that team. At 113, any current member of a team may approve membership in a team by a requesting user. Any current member of a team may deny a user who is requesting membership.

At 114, a member of a team may associate a meme with the team. This association is only accessible to members of the team, except in the case of public teams, as described above. Conversely, a member of a team may disassociate a meme with the team, or the team with any meme. At 115, a member of a team may create a new meme which is only available to members of that team. Note that memes can be created that are accessible to the entire community of users (i.e. the team of everyone), to the creating user only (i.e. team of self), or a specific team that of which that user is a member. The accessibility of a data object (Public/Private/Team Instance) is deemed that data object's “scope.”

At 116, a member of a team may create an annotation which is available only to members of that team. As with memes, annotations can be created that are accessible to the entire community of users (team of everyone), to the creating user only (team of self), or a specific team of which the user is a member. The accessibility of a data object (Public/Private/Team Instance) is deemed that data object's “scope.”

At 117, the owner of a team may delete the team at any time. In this case, the information associated with the team is deleted, and members of the team no longer have access to information associated with the team. At 118, a user that is a member of more than one team may copy memes, URLs, and annotations from one team to another. If the copied data object is scoped to the source team, a new data object is created containing the data fields of the source object scoped to the destination team, which is then associated with that team. If the copied data object is scoped to “Public,” then the data object is associated with the destination team (this data object is accessible to the entire community).

At 119, a user may associate any data object that user has access to with a team that user is a member of. If the data object is scoped “public,” then the public data object is associated with the team. If the data object is scoped “private” or scoped to another team, then a new data object is created containing the data fields of the source object, scoped to the destination team, and this resulting data object is associated with the destination team. At 120, the owner of a team may lock the team so that no new members can be added.

Moreover, the graphic user interface described above provides a tool enabling a process for manipulating semantic data that results in changes to the definition of and/or relationship between data within a semantic network using UMIS to help record such changes. The graphic user interface also provides a tool enabling a process for the manipulation and exchange of semantic data by individuals or groups of individuals that results in changes to the definition of and/or relationship between data within a semantic network using UMIS to help record such changes. Furthermore, the graphic user interface represents a tool enabling a process for the approval of rights to change the definition of and/or relationship between data within a semantic network using UMIS to help record such changes by individuals or groups of individuals. In addition, an Application Program Interface (API) can perform each individual function, that the graphic user interface referenced herein performs, for manipulating semantic data that results in changes to the definition of and/or relationship between data within a semantic network using UMIS to help record such changes. The graphical user interface may thus provide a tool enabling a process for manipulating data in a semantic network. The functions (and actions) described herein are examples of different methods of manipulating semantic data, which are recorded and controlled using the UMIS-resulting in changes to the semantic network.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to any given type of meme, a type of graphical user interface, or a type of database (e.g., relational, object oriented database, and the like).

What is claimed is:

1. A computer-implemented method comprising:
creating a group of one or more members;
manipulating, at a graphical user interface, a meme by associating the meme with at least one member of the group, the meme configured as a data object and the meme including an identifier; and
defining whether the meme is accessible to each of the one or more members.

2. The computer-implemented method of claim 1, wherein the identifier is associated with a semantic concept included within a semantic network.

3. The computer-implemented method of claim 2, wherein the semantic network further comprises a plurality of semantic concepts with relationships defined among two of more of the semantic concepts.

4. The computer-implemented method of claim 1, wherein the identifier is a unique identifier comprising a global authority, an issuer, a namespace, and an instance.

5. The computer-implemented method of claim 1, wherein the meme represents at least one of the following: a person, a place, an organization, a thing, and a concept.

6. The computer-implemented method of claim 1, wherein manipulating further comprises:
creating an annotation to the meme, the annotation configured with a scope defining whether the annotation is accessible to the one or more members.

7. The computer-implemented method of claim 1, wherein manipulating further comprises:
accessing, at a server, the meme being manipulated by the graphical user interface.

8. The computer-implemented method of claim 1 further comprising:
changing, in response to manipulating, semantic data included in a semantic network, the semantic data representative of semantic concepts, the semantic network stored at a server including a universal meme identification system (UMIS), the change to the semantic data corresponding to at least one of a relationship between the semantic data and a definition of the semantic data, the change recorded at the UMIS.

9. The computer-implemented method of claim 1 further comprising:
exchanging the semantic data between at least two members, the exchange resulting in a change to the semantic data included in a semantic network, the semantic data representative of semantic concepts, the semantic network stored at a server including a universal meme identification system (UMIS), the change to the semantic data corresponding to at least one of a relationship between the semantic data and a definition of the semantic data, the change recorded at the UMIS.

10. The computer-implemented method of claim 1 further comprising:
using the graphical user interface to enable rights to change at least one of a relationship between the semantic data and a definition of the semantic data, the change recorded at the UMIS.

11. The computer-implemented method of claim 1 further comprising:
providing, for each function associated with the graphical user interface, an application program interface (API), each function changing at least one of a relationship between semantic data and a definition of the semantic data, the change recorded at a server including a universal meme identification system.

12. A computer-readable medium containing instructions to configure a processor to perform a method, the method comprising:
creating a group of one or more members;
manipulating, at a graphical user interface, a meme by associating the meme with at least one member of the group, the meme configured as a data object and the meme including an identifier; and
defining whether the meme is accessible to each of the one or more members.

13. The computer-readable medium of claim 12, wherein the identifier is associated with a semantic concept included within a semantic network.

14. The computer-readable medium of claim 13, wherein the semantic network further comprises a plurality of semantic concepts with relationships defined among two of more of the semantic concepts.

15. The computer-readable medium of claim 12, wherein the identifier is a unique identifier comprising a global authority, an issuer, a namespace, and an instance.

16. The computer-readable medium of claim 12, wherein the meme represents at least one of the following: a person, a place, an organization, a thing, and a concept.

17. The computer-readable medium of claim 12, wherein manipulating further comprises:
creating an annotation to the meme, the annotation configured with a scope defining whether the annotation is accessible to the one or more members.

18. The computer-readable medium of claim 12, wherein manipulating further comprises:
accessing, at a server, the meme being manipulated by the graphical user interface.

19. A system comprising:
a processor; and
a memory, wherein the processor and the memory are configured to perform a method comprising:
creating a group of one or more members;
manipulating, at a graphical user interface, a meme by associating the meme with at least one member of the group, the meme configured as a data object and the meme including an identifier; and
defining whether the meme is accessible to each of the one or more members.

20. The system of claim 15, wherein the identifier is associated with a semantic concept included within a semantic network.
